(19) United States
(12) Patent Application Publication
(10) Pub. No.: US 2026/0309461 A1
(43) Pub. Date: Oct. 8, 2026

(54) NAVIGATION DEVICE FOR AN OPTICAL SYSTEM FOR AIMING AND OBSERVING A SCENE, AND METHOD FOR DETERMINING AN ATTITUDE FOR SUCH AN OPTICAL SYSTEM

(71) Applicant: SAFRAN ELECTRONICS & DEFENSE, PARIS (FR)

(72) Inventors: Yves MICHELS, MOISSY-CRAMAYEL (FR); Arnaud WOISELLE, MOISSY-CRAMAYEL (FR); Mathieu RENAUDAT, MOISSY-CRAMAYEL (FR)

(21) Appl. No.: 19/483,278

(22) PCT Filed: May 11, 2024
(86) PCT No.: PCT/EP2024/063007

§ 371 Date: Nov. 11, 2025

(30) Foreign Application Priority Data
May 22, 2023 (FR) 2304890

(51) Int. Cl. F41G 1/38; G01C 11/06; G01C 19/34; G01C 19/44; G01C 21/02

(52) U.S. Cl. CPC F41G 1/38; G01C 11/06; G01C 19/34; G01C 19/44; G01C 21/02

(57) ABSTRACT

A navigation device, configured to be securely mounted on an optical system for viewing and observing a scene. The navigation device including an inertial module, a viewing module, at least one database storing a plurality of reference attitudes, each associated with a reference optical signature a computer configured to compare a current inertial attitude with the reference attitudes so as to determine the closest reference attitude and deduce therefrom the associated reference optical signature compare the current image captured by the viewing module with the associated reference optical signature so as to determine an angular offset, and determine the navigation attitude based on the closest reference attitude and on the angular offset.

### TECHNICAL FIELD

The present invention relates to a navigation device for determining an attitude for an optical aiming and observation system, for example, optronic binoculars or a terrestrial sight. In particular, the invention aims to provide a navigation device providing an attitude with a reduced drift.

An optical aiming and observation system, hereinafter “optical system”, allows a scene to be observed at a distance in order to determine, for example, movements of people or activities. Such an optical system may be portable or fixed. In order to accurately determine the position of the observed scene, the optical system is associated with a navigation device for determining the angular orientation of the optical system. The angular orientation is known to the person skilled in the art as the “attitude”. The precise knowledge of the attitude of the optical system means it may be modelled and several areas associated with different angular positions may be observed quickly. This allows to automate shooting or firing or to geolocate friendly or enemy targets.

In a known way, a navigation device comprises at least three gyroscopes for determining the attitude. When it is initialized, the navigation device is calibrated with an astral aiming device or similar in order to determine an initial attitude accurately. In practice, the gyroscopes generate an attitude drift that increases over time, which may distort the determined attitude. At long range, an imprecise attitude may distort the aiming and, for example, cause a shot to miss. An immediate solution would be to carry out frequent calibration operations with the astral aiming device in order to reduce the drift. This means that the observation mission has to be interrupted frequently, which is a major disadvantage. It is therefore not possible to carry out observations lasting several hours.

In the prior art, it has been proposed to equip a navigation device with several accelerometers sensitive to the gravity field in order to correct the drift of the attitude. However, such a solution is only applicable to a two-axis optical system and is not suitable for a three-axis optical system such as a pair of optronic binoculars.

The aim of the invention is to propose a navigation device for an optical system that allows an attitude to be determined accurately and does not require constraints to the operators. In addition, it is important that the navigation device has a low mass, a small overall dimension and is energy-efficient so that it may be used in military operations.

The patent application WO 2022/016260 A1 describes an optical system for measuring an absolute angular orientation from near to near by overlapping images.

### PRESENTATION OF THE INVENTION

The invention relates to a navigation device configured to be securely mounted on an optical system for aiming and observing a scene, the navigation device being configured to determine a navigation attitude, the navigation device comprising:
at least one inertial module, configured to determine a current inertial attitude continuously,
at least one viewing module, configured to capture at least one current image of the scene continuously,
at least one database storing a plurality of reference attitudes, each reference attitude being associated with a reference optical signature,
at least one computer configured to:
   Compare the current inertial attitude with the reference attitudes so as to determine the closest reference attitude and deduce the associated reference optical signature,
   Compare the current image captured by the viewing module with the associated reference optical signature so as to determine an angular offset,
   Determine the navigation attitude from the nearest reference attitude and the angular offset.

Thanks to the invention, any drift of the current inertial attitude may be avoided. A recalibration may be carry out dynamically when the current inertial attitude is close to a reference attitude in the database. Determining an angular deviation from the current image provides a visual measure of any potential drift in the inertial module. In other words, by measuring the relative movements between the images, we may dynamically compensate for drift.

Advantageously, it is not necessary to carry out near detection by overlap. An optical signature is only searched in the database for a nearby reference optical signature. This offers a greater flexibility than a close-by detection.

In one aspect, the computer is configured to determine the associated reference optical signature only when the difference between the current inertial attitude and the closest reference attitude is less than a predetermined attitude threshold. In this way, when the reference data is too far away from the current attitude point, recalibration is avoided. A recalibration is only carried out if quality reference data is available nearby.

According to one aspect, the computer is configured to determine a new reference attitude associated with a new reference optical signature when the difference between the current inertial attitude and the closest reference attitude is greater than a predetermined attitude threshold. The database is enhanced when the operator observes attitudes that have not yet been listed. This means that dynamic recalibrations may be made when these attitudes are reached again.

According to one aspect, the new reference attitude corresponds to the current inertial attitude and the new reference optical signature is determined from the current image.

According to one aspect, the computer is configured to estimate, on the one hand, a first uncertainty for the current inertial attitude and, on the other hand, a second uncertainty for the navigation attitude, the computer being configured to use the current inertial attitude as the navigation attitude if the first uncertainty is less than the second uncertainty. In this way, the drift is controlled by estimating the uncertainty and avoiding an untimely correction.

In one aspect, the inertial module and the viewing module are physically secured in their movements. It goes without saying that they may aim in different directions, in particular by using harmonization matrices defining the deviation between the aiming directions.

In one aspect, the inertial module comprises at least three gyroscopes in order to determine a precise inertial attitude.

The invention also relates to an assembly of an observation system and a navigation device as presented above. Preferably, the navigation device is integrated into the observation system.

According to one aspect, the observation system is in the form of optronic binoculars or a terrestrial sight.

The invention also relates to a method for determining a navigation attitude by a navigation device as previously presented, the navigation device being securely mounted on an optical system for aiming and observing a scene, the method comprising steps consisting of:
Comparing the current inertial attitude with the reference attitudes so as to determine the closest reference attitude and deduce the associated reference optical signature,
Comparing the current image captured by the viewing module with the associated reference optical signature so as to determine an angular offset, and
Determining the navigation attitude from the nearest reference attitude and the angular offset.

According to one aspect, the method comprises a step consisting of initializing the current attitude by means of an astral aiming device. This allows to obtain an ideal reference before carrying out an observation. In this way, quality reference data may be obtained for the database at the start of observation.

The invention also relates to a product of the computer program type, comprising at least one sequence of instructions stored and readable by a processor and which, once read by this processor, causes the steps of the method as presented above to be carried out.

The invention also relates to a computer-readable medium comprising the computer program type product as presented above.

### PRESENTATION OF FIGURES

The invention will be better understood on reading the following description, given by way of example, with reference to the following figures, given by way of non-limiting examples, wherein identical references are given to similar objects.

FIG. 1 is a schematic representation of an operator observing a scene by means of an optical system on which a navigation device is mounted.

FIG. 2 is a schematic representation of a navigation device according to one embodiment of the invention.

FIG. 3 is a schematic representation of an aiming point on a current image.

FIG. 4 is a schematic representation of a first example of aiming at a scene.

FIG. 5 is a schematic representation of a second example of aiming at a scene.

FIG. 6 is a schematic representation of the evolution of an attitude drift according to the prior art and according to the invention for an example of modification of the angular position.

It should be noted that the figures set out the invention in detail in order to implement the invention, said figures of course being able to be used to better define the invention if necessary.

### DETAILED DESCRIPTION OF THE INVENTION

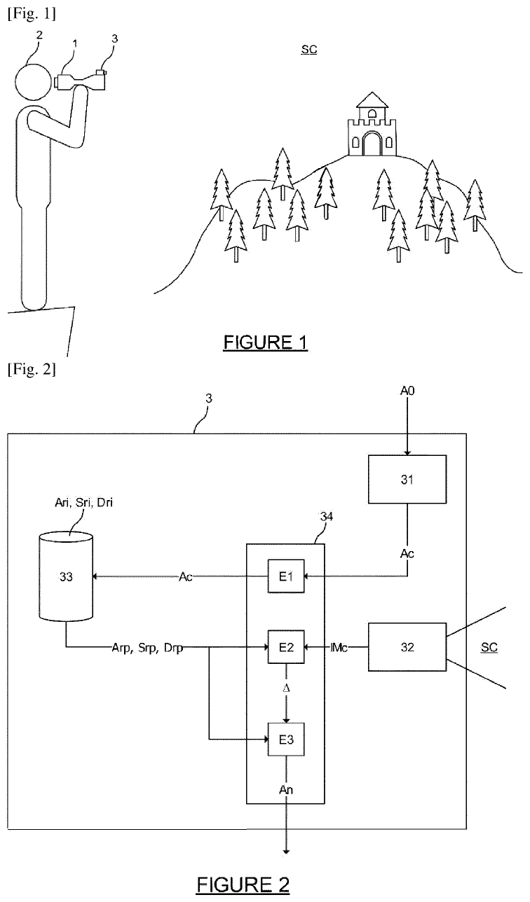

With reference to FIG. 1, an operator 2 is shown observing an external scene SC at a long distance, by means of an optical aiming and observation system 1, hereinafter referred to as “optical system 1”. In this example, the optical system 1 is a pair of optronic binoculars, but it goes without saying that the optical system 1 may take the form of an aiming system mounted on a rifle or a missile.

Preferably, the optical system 1 comprises an acquisition sensor, for example a camera. An optical system 1 of this type is already known to the person skilled in the art and will not be described in further detail. In order to determine the orientation of the optical system 1, i.e. its attitude, a navigation device 3 is associated with the optical system 1.

In this example, with reference to FIG. 1, the navigation device 3 is permanently or removably fixed to the optical system 1. The navigation device 3 is therefore secured to its movements of the optical system 1. Any change in the angular orientation of the optical system 1 results in a change in the angular orientation of the navigation device 3.

It goes without saying that the navigation device 3 and the optical system 1 may be integrated into the same item of equipment. For example, the navigation device 3 may be integrated directly into a housing of the optical system 1.

A navigation device 3 is shown schematically in FIG. 2 according to one embodiment of the invention. The navigation device 3 is configured to determine a navigation attitude An corresponding to that of the optical system 1.

With reference to FIG. 2, the navigation device 3 comprises:
an inertial module 31, configured to determine a current inertial attitude Ac continuously,
a viewing module 32, configured to capture at least one current image IMc of the scene SC continuously,
a database 33 storing a plurality of reference attitudes Ari, each reference attitude Ari being associated with a reference optical signature Sri,
a computer 34 configured to determine the navigation attitude An from the current inertial attitude Ac, the current image IMc and the database 33.

The various elements of the navigation device 3 will now be described. They are preferably powered by an electric battery (not shown).

In this example, the inertial module 31 comprises three gyroscopes determining a current inertial attitude Ac of the navigation device 3, and therefore of the optical system 1. The current inertial attitude Ac is determined by reference to an initial attitude AO obtained by calibration from an external navigation system, in particular an astral aiming device or a compass. The current inertial attitude Ac is determined, for example, by integrating the angular velocities of the three gyroscopes. As presented in the preamble, the current inertial attitude Ac has an increasing drift over time. The current inertial attitude Ac is determined continuously by the inertial module 31.

In this example, the viewing module 32 comprises an optical sensor, in particular a camera, directed towards the external scene SC. The viewing module 32 is configured to capture a current image IMc of the scene SC continuously. It is specified that the current image IMc is independent of the images of the scene SC acquired by the optical system 1. However, it is possible that the current image IMc is identical to that acquired by the optical system 1. Preferably, the viewing module 32 and the inertial module 31 are secured to each other in order to maintain a consistency between the data. It goes without saying that the viewing module 32 may belong to the optical system 1.

In this example, still referring to FIG. 2, the database 33 stores a plurality of reference attitudes Ari associated with a reference optical signature Sri and a reference date Dri. A reference optical signature Sri is determined from at least one portion of a current image IMc captured for said reference attitude Ari by the viewing module 32. Preferably, the reference optical signature Sri is determined by an image processing algorithm. By way of example, the reference optical signature Sri corresponds to an assembly of data (generally a few thousand values) used to estimate a geometric deformation between two images, in particular between the current image IMc and the image used to form the reference optical signature Sri. A reference optical signature Sri has a reduced weight and characterizes the image visible by the viewing module 32 when it is oriented at the reference attitude Ari. This allows to have a database 33 with a large number of reference attitudes Ari, while at the same time reducing weight. It is therefore advantageous for the database 33 to be fully embedded. This reduces the weight and overall dimension of the optical aiming and observation system. In addition, the reduced weight of the reference optical signature Sri reduces computing requirements and therefore power consumption. This is particularly advantageous when the optical system 1 is on-board.

The reference date Dri corresponds to the current date when the reference optical signature Sri is determined. This allows to delete the reference data Sri, Dri, Ari that has become obsolete due to its age. The reference date Dri is optional.

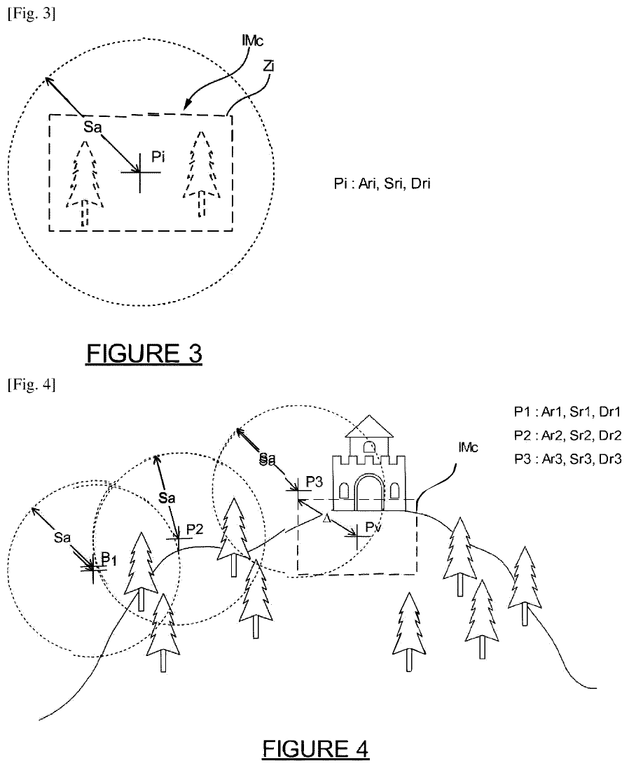

By way of example, with reference to FIG. 3, the current image IMc seen by the optical device 32 in aim at a reference point Pi corresponding to the reference attitude Ari is shown schematically. In this example, a rectangular reference area Zi is determined in the vicinity of the reference point Pi and the reference optical signature Sri is determined by calculation from the pixels comprised in the reference area Zi. It goes without saying that the reference area Zi may have a different shape.

With reference to FIG. 4, three reference points P1, P2, P3 are shown schematically, corresponding respectively to three reference attitudes Ar1, Ar2, Ar3 associated with three reference optical signatures Sr1, Sr2, Sr3 and three reference dates Dr1, Dr2, Dr3.

The computer 34 is in the form of a processor, a motherboard, an EPGA or the like and allows calculation operations to be carried out.

According to one aspect of the invention, as illustrated in FIG. 2, the computer 34 is configured, according to a first step E1, to compare the current inertial attitude Ac with the reference attitudes Ari in the database 3 so as to determine the closest reference attitude Arp and deduce therefrom the associated reference optical signature, hereinafter referred to as the “closest optical signature Srp”. The reference date Drp of the nearest optical signature Srp is also obtained in this example.

With reference to FIG. 2, the computer 34 is further configured, according to a second step E2, to compare the current image IMc captured by the viewing module 32 with the closest optical signature Srp so as to determine an angular offset Δ.

According to one aspect of the invention, the optical signature corresponds to the average of the pixels in the rows and columns of the image. For example, to determine the angular offset Δ, the translations in the rows and columns are first determined by correlating the current image signature IMc with the optical reference signatures Sr1, Sr2, Sr3 in order to deduce a specific translation. A geometric transformation is then applied to transform the transformation determined into an angular offset Δ.

According to another aspect, the optical signature corresponds to high gradient pixels in the image. To determine the angular offset Δ, we calculate the geometric deformation that allows the high-gradient pixels to be recalibrated. It goes without saying that other methods may be appropriate.

In practice, the current image IMc is recalibrated to the nearest optical signature Srp in order to estimate the translation and the rotation, i.e. a rigid deformation, between the current image IMc and the nearest optical signature Srp. The angular offset 4 thus corresponds to a measure of geometric deformation.

The computer 34 is further configured, according to a third step E3, to determine the navigation attitude An from the closest reference attitude Arp and the angular offset 4. This advantageously allows any drift in the current inertial attitude Ac to be corrected. In this way, the computer 34 may determine a navigation attitude An based on measurements taken in the past which are deemed to be correct. Advantageously, this determination may be carried out routinely when the operator 2 is using the optical system 1. Preferably, the navigation attitude An, the closest reference attitude Arp and the angular offset Δ are connected by a mathematical formula that has been determined in advance.

According to one aspect, the computer 34 is configured to estimate the quality of the navigation attitude An which has been determined, for example, as a function of the following criteria: angular velocity below a fixed threshold, sufficiently high level of contrast in the current image, etc. The computer 34 is configured to reject the navigation attitude An if the quality is too low.

Preferably, a navigation attitude An is determined only if the difference between the current inertial attitude Ac and the closest reference attitude Arp is less than or equal to a predetermined attitude threshold Sa. Indeed, if the difference is too great, the navigation attitude An that would be determined would lack precision.

Also, in a preferred manner, if the difference between the current inertial attitude Ac and the closest reference attitude Arp is greater than the predetermined attitude threshold Sa, the computer 34 is configured to store in the database 33 a new reference attitude Ari equal to the current inertial attitude Ac with a new reference optical signature Sri determined from the current image IMc. A reference date Dri is also associated with the new reference attitude Ari. This allows to increase the size of the database 33 with reference attitudes that had not been determined in the past. When using the optical system 1, this will allow a navigation attitude An to be determined accurately, as there will be more reference attitudes Ari. As before, the computer 34 is configured to reject the new reference attitude Ari if the quality is too low.

According to one aspect, the computer 34 is configured to estimate, on the one hand, a first uncertainty for the current inertial attitude Ac and, on the other hand, a second uncertainty for the navigation attitude An. Preferably, uncertainties are estimated by computer learning or by integrating a previously a calibrated error model. Preferably, the database 33 associates each reference attitude Ari with an uncertainty, i.e. that of the current inertial attitude Ac at the time of recording in the database 33.

If the first uncertainty is less than the second uncertainty, the computer 34 is configured to use the current inertial attitude Ac as the navigation attitude An. In other words, the navigation attitude An that has been determined is not retained because of its high degree of uncertainty.

In order to maintain a highly relevant database 33, the reference attitudes Ari associated with reference dates Dri that are more than 20 minutes old, for example, are deleted to allow more recent reference data to be stored.

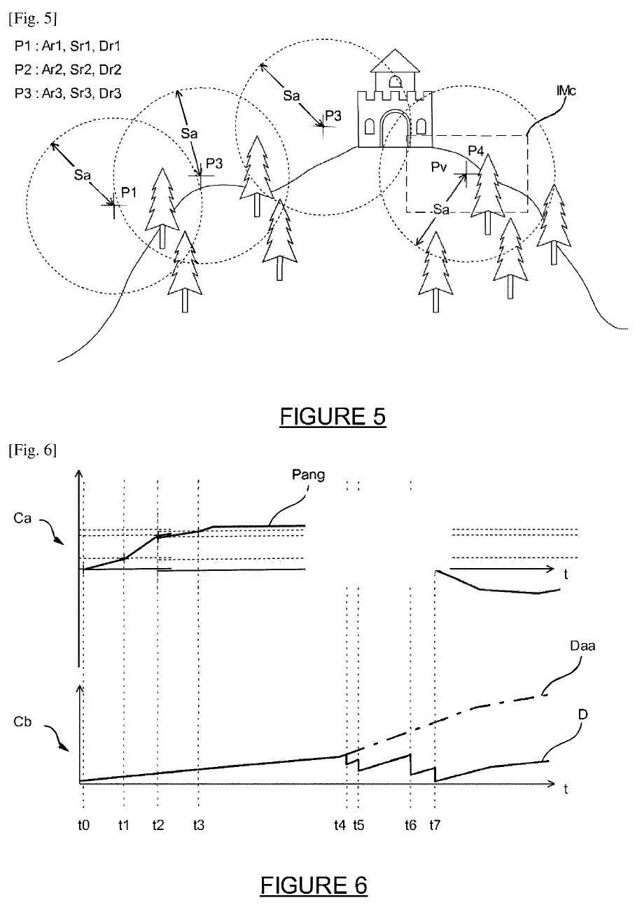

An example of implementation of the invention will now be presented with reference to FIGS. 4 to 5. In this example, with reference to FIG. 4, there is a schematic representation of a scene SC showing three reference points P1, P2, P3 corresponding respectively to three reference attitudes Ar1, Ar2, Ar3 associated with three reference optical signatures Sr1, Sr2, Sr3 and three reference dates Dr1, Dr2, Dr3. For the sake of clarity, the predetermined attitude threshold Sa is represented in the form of a circle for each reference point P1, P2, P3.

In practice, at the start of a mission, the database 33 does not comprise any reference attitudes and these are learned during the mission. In this example, three reference attitudes Ar1, Ar2, Ar3 have already been learned.

The operator 2 wishes to observe the scene with the optical system 1 and with the viewing module 32 of the navigation device 3. It first calibrates the inertial module 31 of the navigation device 3 by means of the astral aiming device. So the current inertial attitude Ac corresponds to the initial attitude A0.

Then, as illustrated in FIG. 4, the operator orients the optical system 1 with the navigation device 3 towards the scene SC according to a aiming attitude which is represented by an aiming point Pv in FIG. 4. In this example, the aiming point Pv is at the center of the current image IMc The navigation device 3 determines the closest reference attitude Arp. To this end, the different reference optical signatures Sr1, Sr2, Sr3 are compared with an area defined in the vicinity of the aiming point Pv in the current image IMc. In this example, this comparison is carried out by an image processing algorithm implementing correlation operations.

In this example, the third reference optical signature Sr3 is the closest. So the closest reference attitude Arp is the third reference attitude Ar3 associated with the third reference point P3. Given that the difference between the current inertial attitude Ac and the third reference attitude Ar3 is less than the predetermined attitude threshold Sa as illustrated in FIG. 4, the navigation device 3 may determine a navigation attitude An from this third reference attitude Ar3.

The computer 34 first determines an angular offset Δ between the current image IMc captured by the viewing module 32 and the third reference optical signature Sr3. It may then determine the navigation attitude An from the closest reference attitude Arp and the angular offset Δ. This gives a practical navigation attitude An that corrects any drift in the current inertial attitude Ac.

Preferably, as explained above, if the current inertial attitude Ac has a low uncertainty, which is for example the case shortly after an astral calibration, the current inertial attitude Ac is used as the navigation attitude An.

During observation, the operator changes the orientation of the optical system 1 as shown in FIG. 5. The aiming point Pv is then changed. In this example, the third reference optical signature Sr3 is the closest. The closest reference attitude Arp is also the third reference attitude Ar3 associated with the third reference point P3. In this example, given that the difference between the current inertial attitude Ac and the third reference attitude Ar3 is greater than the predetermined attitude threshold Sa, the navigation device 3 does not determine a navigation attitude An but stores new reference data in the database 33 by determining a fourth reference attitude Ar4 (corresponding to the current inertial attitude Ac) associated with a fourth reference optical signature Sr4 (determined in the current image IMc in the vicinity of the aiming point Pv) and a fourth reference date Dr4.

Advantageously, the database 33 increases in size and allows to increase the accuracy and carry out dynamic calibrations during use of the optical system 1.

With reference to FIG. 6, a first curve Ca shows the evolution of an angular position Pang of the optical system 1 over time. As illustrated in the figure, the angular position gradually increases to reach a plateau and then gradually decreases again to reach known angular positions. Thus, the angular positions reached at time instants t0, t1, t2, t3 are identical to the angular positions reached respectively at time instants t7, t6, t5, t4 as illustrated in FIG. 6.

With reference to FIG. 6, a second curve Cb shows the evolution of the attitude drift Daa according to the prior art and the evolution of the attitude drift D according to the invention. It may be seen that in the prior art, the drift increases over time and may become very high, which leads to high inaccuracies. Conversely, thanks to the invention, it may be seen that the drift is reduced each time the navigation device 3 recovers an angular position already encountered in the past (time instants t7, t6, t5, t4), i.e. a reference attitude Ari determined in the database 33. As a result, the attitude drift D is dynamically corrected and may be contained over time. Thanks to the invention, it is possible to provide a precise attitude during use of the optical system in order to carry out observations over several hours. Advantageously, the navigation device 3 has a low mass, a small overall dimension and low energy consumption so that it may be used in military operations.

1. A navigation device configured to be securely mounted on an optical system for aiming and observing a scene, the navigation device being configured to determine a navigation attitude the navigation device comprising:
at least one inertial module configured to determine a current inertial attitude continuously,
at least one viewing module configured to capture at least one current image of the scene continuously, the inertial module and the viewing module being physically secured in their movements,
at least one database storing a plurality of reference attitudes each of the reference attitudes being associated with a reference optical signature, and
at least one computer configured to:
compare the current inertial attitude with the reference attitudes so as to determine the closest reference attitude and deduce the associated reference optical signature,
compare the current image captured by the viewing module with the associated reference optical signature so as to determine an angular offset, and
determine the navigation attitude from the nearest reference attitude and the angular offset

2. The navigation device as claimed in claim 1, wherein the computer is configured to determine the associated reference optical signature only when the difference between the current inertial attitude and the closest reference attitude is less than a predetermined attitude threshold.

3. The navigation device according to claim 1, wherein the computer is configured to determine a new reference attitude associated with a new reference optical signature when the difference between the current inertial attitude and the closest reference attitude is greater than a predetermined attitude threshold.

4. The navigation device according to claim 3, wherein the new reference attitude corresponds to the current inertial attitude and the new reference optical signature is determined from the current image.

5. The navigation device according to claim 1, wherein the computer is configured to estimate, on the one hand, a first uncertainty for the current inertial attitude and, on the other hand, a second uncertainty for the navigation attitude the computer being configured to use the current inertial attitude as the navigation attitude if the first uncertainty is less than the second uncertainty.

6. An assembly of the optical system and the navigation device according to claim 1.

7. The assembly according to claim 6, wherein the optical system is at least one of optronic binoculars and a terrestrial sight.

8. A method for determining the navigation attitude by the navigation device according to claim 1, the method comprising:
comparing the current inertial attitude with the reference attitudes so as to determine the closest reference attitude and deduce the associated reference optical signature,
comparing the current image captured by the viewing module with the associated reference optical signature so as to determine the angular offset, and
determining the navigation attitude from the nearest reference attitude and the angular offset.

9. The method according to claim 8, further comprising:
initializing the current attitude by an astral aiming device.
